(19) United States
(12) Patent Application Publication
(10) Pub. No.: US 2013/0325838 A1
(43) Pub. Date: Dec. 5, 2013

(54) METHOD AND SYSTEM FOR PRESENTING QUERY RESULTS

(71) Applicant: Ying-Hsiang Liao, Taipei (TW)

(72) Inventor: Ying-Hsiang Liao, Taipei (TW)

(73) Assignee: Yahoo! Inc., Sunnyvale, CA (US)

(21) Appl. No.: 13/488,513

(22) Filed: Jun. 5, 2012

(51) Int. Cl. G06F 17/30

(52) U.S. Cl. 707/707; 707/722; 707/E17.108; 707/E17.082

(57) ABSTRACT

Method, system, and programs for presenting query results are disclosed. An input is received from a user related to a search query. A first set of query results and a second set of query results are then obtained based on the search query. A query intent is detected based on the search query. A first presentation style associated with the detected query intent is determined for the first set of query results. The first and second sets of query results are provided to the user. The first set of query results are presented in the first presentation style.

### BACKGROUND

1. Technical Field

The present teaching relates to methods, systems, and programming for Internet services. Particularly, the present teaching is directed to methods, systems, and programming for presenting query results.

2. Discussion of Technical Background

Online content search is a process of interactively searching for and retrieving requested information via a search application running on a local user device, such as a computer or a mobile device, from online databases. Online search is conducted through search engines, which are programs running at a remote server and searching documents for specified keywords and return a search result page including a list of the documents where the keywords were found. Known major search engines have features called “sponsored search” designed to provide purchase opportunities wherever users may be surfing. For example, websites that utilize “Pay-Per-Click” (PPC) advertisement will display an advertisement when a keyword query matches an advertiser's keyword list, or when a content site displays relevant content. Such advertisement results are called sponsored links or sponsored advertisement, and may appear adjacent to or above regular results (“Algo” algorithmic results) on search engine result pages, or anywhere a web developer chooses on a content site answers to their search queries before they hit the actual search button or any specific hyperlink.

Some known search engines distinguish sponsored query results from regular query results by apply different presentation styles, e.g., background color, to sponsored query results and regular query results. The presentation style of the sponsored query results, however, is static. For example, a constant and uniform presentation style is applied to different sponsored query results obtained by different search queries, which bores users and lacks the effect of stimulating users to click the sponsored links.

Therefore, there is a need to provide an improved solution for presenting query results to solve the above-mentioned problems.

### SUMMARY

The present teaching relates to methods, systems, and programming for Internet services. Particularly, the present teaching is directed to methods, systems, and programming for presenting query results.

In one example, a method, implemented on at least one machine each of which has at least one processor, storage, and a communication platform connected to a network for presenting query results, is disclosed. An input is received from a user related to a search query. A first set of query results and a second set of query results are then obtained based on the search query. A query intent is detected based on the search query. A first presentation style associated with the detected query intent is determined for the first set of query results. The first and second sets of query results are provided to the user. The first set of query results are presented in the first presentation style.

In another example, a method, implemented on at least one machine each of which has at least one processor, storage, and a communication platform connected to a network for presenting query results, is disclosed. A plurality of presentation styles are associated with a plurality of query intents. One of the plurality of presentation styles is determined based on one of the plurality of query intents. The one of the plurality of query intents is detected based on a search query. The determined presentation style is applied to one or more query results obtained based on the search query. A rate of accessing at least one of the one or more query results presented in the determined presentation style is determined. The determined presentation style is modified based on the determined rate.

In a different example, a system for presenting query results is disclosed. The system comprises a search engine, a query intent module, and a presentation style module. The search engine is configured to receive an input from a user related to a search query and obtain a first set of query results and a second set of query results based on the search query. The query intent module is configured to detect a query intent based on the search query. The presentation style module is configured to determine a first presentation style associated with the detected query intent for the first set of query results. The search engine is further configured to provide the first and second sets of query results to the user. The first set of query results are presented in the first presentation style.

In another example, a system for presenting query results is disclosed. The system comprises a mapping unit, an assigning unit, and a refining unit. The mapping unit is configured to associate a plurality of presentation styles with a plurality of query intents. The assigning unit is configured to determine one of the plurality of presentation styles based on one of the plurality of query intents. The one of the plurality of query intents is detected based on a search query. The assigning unit is also configured to apply the determined presentation style to one or more query results obtained based on the search query. The refining unit is configured to determine a rate of accessing at least one of the one or more query results presented in the determined presentation style. The refining unit is also configured to modify the determined presentation style based on the determined rate.

Other concepts relate to software for presenting query results. A software product, in accordance with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine readable and non-transitory medium having information recorded thereon for presenting query results, wherein the information, when read by the machine, causes the machine to perform a series of steps. An input is received from a user related to a search query. A first set of query results and a second set of query results are then obtained based on the search query. A query intent is detected based on the search query. A first presentation style associated with the detected query intent is determined for the first set of query results. The first and second sets of query results are provided to the user. The first set of query results are presented in the first presentation style.

In another example, a machine readable and non-transitory medium having information recorded thereon for presenting query results, wherein the information, when read by the machine, causes the machine to perform a series of steps. A plurality of presentation styles are associated with a plurality of query intents. One of the plurality of presentation styles is determined based on one of the plurality of query intents. The one of the plurality of query intents is detected based on a search query. The determined presentation style is applied to one or more query results obtained based on the search query. A rate of accessing at least one of the one or more query results presented in the determined presentation style is determined. The determined presentation style is modified based on the determined rate.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a high level exemplary system diagram of a system for presenting query results, according to an embodiment of the present teaching;

FIG. 2 depicts an exemplary interface between a user and a search engine for presenting query results, according to an embodiment of the present teaching;

FIG. 3 is a flowchart of an exemplary process for presenting query results, according to an embodiment of the present teaching;

FIG. 4 is an exemplary diagram of a presentation style module of the system for presenting query results shown in FIG. 1, according to an embodiment of the present teaching;

FIG. 5 is a flowchart of an exemplary process for a presentation style module of the system for presenting query results, according to an embodiment of the present teaching;

FIG. 6 is an exemplary diagram of a query intent module of the system for presenting query results shown in FIG. 1, according to an embodiment of the present teaching;

FIG. 7 depicts an exemplary query result page, according to an embodiment of the present teaching;

FIG. 8 depicts another exemplary query result page, according to an embodiment of the present teaching;

FIG. 9 depicts still another exemplary query result page, according to an embodiment of the present teaching;

FIG. 10 depicts yet another exemplary query result page, according to an embodiment of the present teaching;

FIG. 11 depicts an exemplary embodiment of a networked environment in which query results presentation is applied, according to an embodiment of the present teaching; and

FIG. 12 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of efficient and effective query results presentation. The method and system as disclosed herein present sponsored query results in a style that is dynamically changed based on detected query intent, thereby psychosocially implicitly encouraging users to click more advertisement links without bothering them. The dynamically determined presentation style, e.g., background color, implicitly drive the users to click more advertisements. The present disclosure reveals that users' clicking behavior is motivated by presentation style of advertising. For example, based on YAHOO! Search internal tracking data, there was about 7% revenue increase when the background color of the Sponsored Search section was changed.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

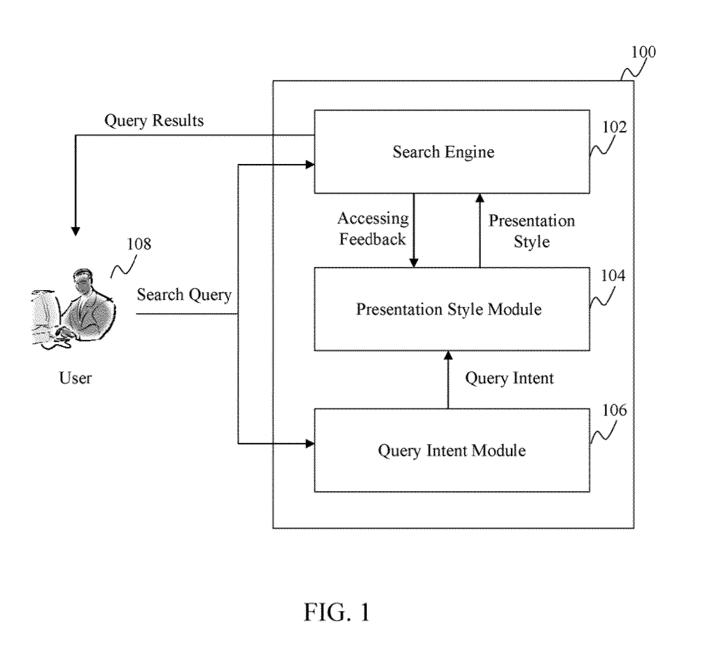

FIG. 1 is a high level exemplary system diagram of a system for presenting query results, according to an embodiment of the present teaching. The system 100 in this example includes a search engine 102, a presentation style module 104, and a query intent module 106. A user 108 in this example performs an online search through a search application on a user device using the backend search engine 102. For example, the user 108 provides a search query to the search engine 102 and query intent module 106 and receives query results from the search engine 102 in a presentation style, which is dynamically determined by the presentation style module 104 based on a query intent detected by the query intent module 106. The query intent module 106 in this example is configured to detect the query intent based on the search query. The presentation style module 104 is configured to determine the presentation style associated with the detected query intent for sponsored query results.

The user device (not shown) may be a laptop computer, desktop computer, netbook computer, media center, mobile device (e.g., a smart phone, tablet, music player, and GPS), gaming console, set-top box, printer, or any other suitable device. A search application, such as a web browser or a standalone search application, may be pre-installed on the user device by the vendor of the user device or installed by the user 108. The search application may serve as an interface between the user 108 and the remote search engine 102. The search application may be stored in a storage on the user device and loaded into a memory once it is launched by the user 108. The search engine 102 in this example may be any suitable search engine responsible for analyzing the received query from the user 108, fetching both sponsored and regular query results, and providing the query results in suitable presentation styles to the user 108.

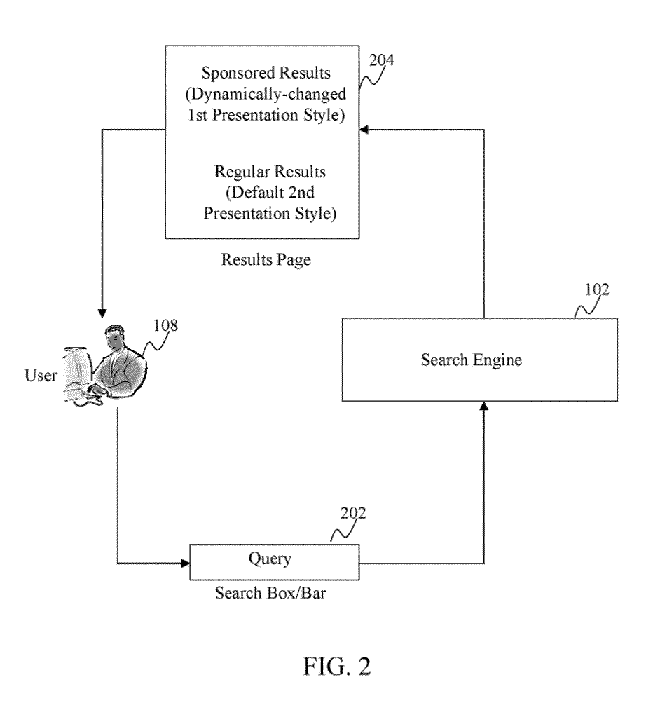

Referring now to FIG. 2, the search application, such as a web browser, includes a search box/bar 202 where search queries can be entered by the user 108. The search query may be any keyword, partial keyword (e.g., characters or strings), image, audio, video, etc. The search engine 102 is responsible for return a list of query results to the search application based on the search query. The search application may include result page(s) 204 for presenting the query results to the user 108 as a response to the inputted search query. The query results may be in the form of, for example, hyperlink (e.g., URL), image (e.g., website snapshot), video, audio, etc. In this example, the query results include at least two major categories: sponsored query results obtained by PPC or any suitable biding model and regular query results. The sponsored query results and regular query results may be presented on the same result page 204 in different presentation styles. For example, the sponsored query results are presented in a dynamically-changed presentation style that is determined based on query intent of the corresponding search query, and the regular query results are presented in a default presenting style that is constant and uniform for all the regular query results.

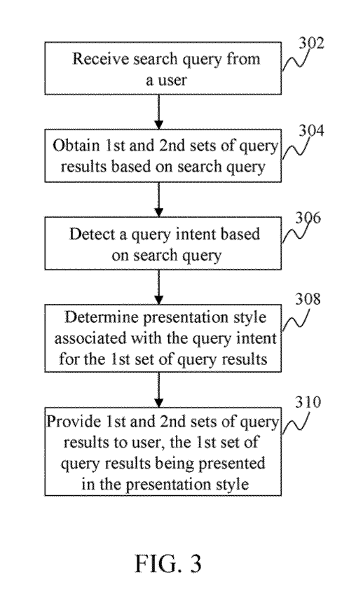

FIG. 3 is a flowchart of an exemplary process in which query results presentation is performed, according to an embodiment of the present teaching. It will be described with reference to the above figures. However, any suitable module or unit may be employed. Beginning at block 302, an input related to a search query from a user is received. At block 304, a first set of query results and a second set of query results are obtained based on the received search query. The first set of query results may be sponsored query results, and the second set of query results may be regular query results. As described above, blocks 302, 304 may be performed by the search engine 102. At block 306, processing may continue where a query intent is detected based on the search query. As described above, this may be performed by the query intent module 106. Moving to block 308, a first presentation style associated with the detected query intent is determined for the first set of query results (e.g., sponsored query results). The presentation style may have been previously assigned to the detected query intent.

The presentation style includes, but is not limited to, background (e.g., background color, transparency, gradient, texture, pattern, picture, etc.), font (e.g., font type, color, style, size, effect, etc.), position (i.e., where the query results are located on the result page), frame (e.g., frame style, color, dash, weight, etc.), image, video, audio, screenshot, or any other suitable presentation style. For example, a pink background color may be associated with a query intent “romance” and may be applied to sponsored query results of any search query that has an intent of “romance,” such as “rose,” “valentine's day,” etc. Eventually, at block 310, the first and second sets of query results are provided to the user. The first set of query results (e.g., sponsored query results) are presented in the first presentation style determined at block 308. As described above, blocks 308, 310 may be performed by the presentation style module 104.

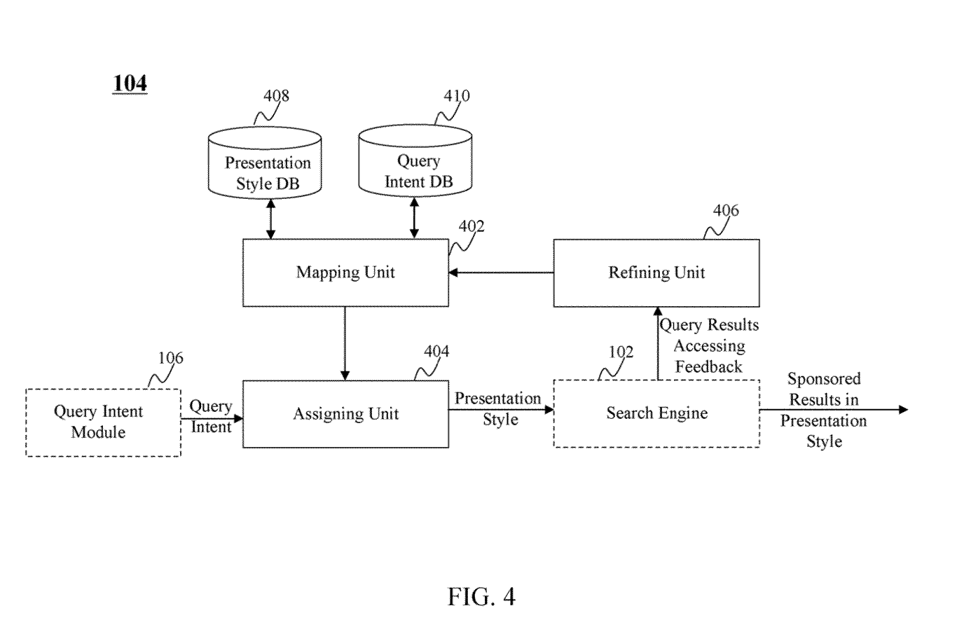

FIG. 4 is an exemplary diagram of a presentation style module of the system for presenting query results shown in FIG. 1, according to an embodiment of the present teaching. The presentation style module 104 in this example includes a mapping unit 402, an assigning unit 404, and a refining unit 406. The mapping unit 402 is configured to associate a plurality of presentation styles with a plurality of query intents. In this example, predetermined presentation styles and query intents are stored in the presentation style database 408 and query intent database 410, respectively. The presentation styles and query intents may be automatically or manually defined and updated in the databases 408, 410. For example, each predetermined presentation style may include different a background, font, and/or frame. As to the query intents, a number of categories, such as “sports,” “travel,” “cars,” etc., may be predefined as possible query intents and stored in the query intent database 410. The mapping unit 402 is then responsible for associating each of predetermined query intent with one of the predetermined presentation styles. The association between a presentation style and a query intent may be based on matching of certain characteristics therebetween. In one example, a presentation style with a pink background color is associated with the query intent “romance.” In another example, a landscape image background with a transparent effect is associated with the query intent “travel.” It is also understood that the association may be arbitrary. For example, different background colors may be randomly assigned to a number of query intents. Initially, the association/mapping may be manually performed or randomly assigned. As time goes by, the association/mapping may be automatically refined by the refining unit 406 through a feedback loop and/or manually adjusted based on the query results accessing feedback (e.g., advertisement click rate).

The assigning unit 404 in this example is configured to determine one of the plurality of presentation styles based on one of the plurality of query intents, which is detected based on the search query by the query intent module 106. The assigning unit 404 may look up the presentation style from the presentation style database 408 by matching its associated query intent. For example, if a query intent “romance” is provided by the query intent module 106, the assigning unit 404 may retrieve the presentation style with pink background from the presentation style database 408. The determined presentation style is then applied to the sponsored query results obtained by the search engine 102. For example, a list of flower shops, which are sponsored links of the query “rose,” may be presented on a pink background. As described above, regular query results may be presented in a default presentation style, e.g., white background, on the same result page with the sponsored query results. The presentation style is dynamically determined for each search query. That is, once a new search query is received, a different query intent may be detected by the query intent module 106 and provided to the assigning unit 404. The assigning unit 404 is then responsible for determining a presentation style associated with the new query intent and applying it to the corresponding sponsored query results. By doing so, the users who receive the query results will be attracted by the dynamically changed presentation styles, thereby being stimulated to click the sponsored query results.

The refining unit 406 in this example is configured to determine a rate of accessing at least one of the query results presented in the determined presentation style and modify the determined presentation style based on the determined rate. For example, the accessing feedback of the sponsored query results is collected by the search engine 102 and provided to the refining unit 406. By analyzing the effect of stimulating users' click rate caused by the presentation style for a particular query intent, the refining unit 406 may decide whether the presentation style needs to be modified. The modification may include reassigning a different presentation style in the presentation style database 408 to the query intent and creating a new presentation style for the query intent. In any event, the refining unit 406 continuously runs to keep optimizing the available presentation styles in the presentation style database 408 and/or refining the mapping between the presentation styles and the available query intents. It is understood that human intervention, e.g., human decision-making and manual modification, may be involved in both the initial mapping process and the later refining process.

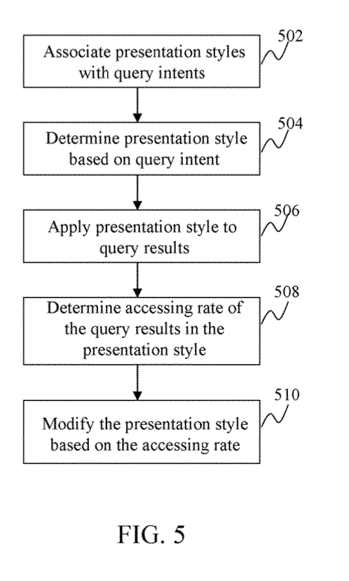

FIG. 5 is a flowchart of an exemplary process for a presentation style module, according to an embodiment of the present teaching. It will be described with reference to the above figures. However, any suitable module or unit may be employed. Beginning at block 502, a plurality of presentation styles are associated with a plurality of query intents. As described above, this may be performed by the mapping unit 402. At block 504, one of the plurality of presentation styles is determined based on one of the plurality of query intents. This query intents is detected based on a search query. At block 506, processing may continue where the determined presentation style is applied to one or more query results obtained based on the search query. As described above, blocks 504, 506 may be performed by the assigning unit 404. At block 508, a rate of accessing at least one of the one or more query results presented in the determined presentation style is determined. Moving to block 510, the determined presentation style is modified based on the determined rate. As described above, blocks 508, 510 may be performed by the refining unit 406.

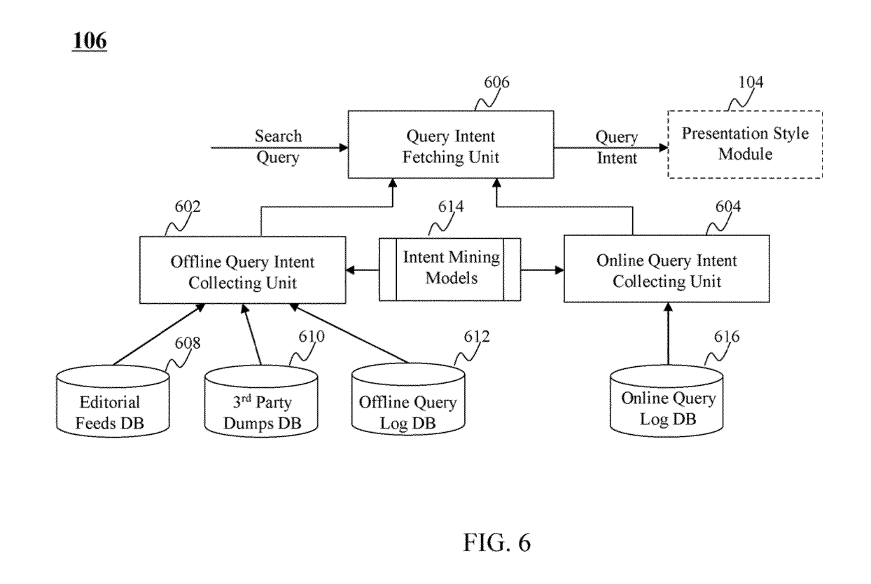

FIG. 6 is an exemplary diagram of a query intent module of the system for presenting query results shown in FIG. 1, according to an embodiment of the present teaching. The query intent detection by the query intent module 106 disclosed herein may be realized using a wide range of techniques. One example is disclosed in corresponding U.S. patent application Ser. No. 13/449,748, having a title “Method and System for Query Suggestion,” and U.S. patent application Ser. No. 13/449,568, having a title “Method and System for Search Assistance,” which are incorporated herein by reference. The query intent module 106 in this example includes an offline query intent collecting unit 602, an online query intent collecting unit 604, and a query intent fetching unit 606.

The offline query intent collecting unit 602 may collect offline intent information from one or more offline sources, such as an editorial feeds database 608, third party dumps database 610, and offline query log database 612. The editorial feeds database 608 may include user intents explicitly programmed by an editorial. For example, a feed list of all popular celebrity names or band names may be used for capturing user intents to find information about the corresponding celebrity or band. Such feeds or lists may be regularly updated by an editorial, in order to reflect the hottest events or newly formed bands. As to the third party dumps database 610, any third party partners of the system 100 may provide content, and the system 100 may display their content as appropriate for the users when the content suits their intents. For example, the third party partner may provide a list of items, which may be converted to searchable queries, for each of their content explicitly. The offline query log database 612 may include a very large number of historical query logs from users. From the query logs, the offline query intent collecting unit 602 may get hold of the information of the query terms and which user intents were detected for this query by any known intent mining models 614, such as data aggregation and data joining algorithms.

Similarly, the online query intent collecting unit 604 may collect online query intent information from an online query log database 616. The online query intent collecting unit 604 collects online intent information based on the search query. In this example, the user information, such as user location or user basic attributes, e.g., age, gender, occupation, etc., may be also obtained by the online query intent collecting unit 604 for detecting possible search intents. The detection may be performed by data mining approaches on online query log database 616 using any known intent mining models 614. Time-sensitive intents are online collected in a continuous and real-time manner. The online and offline intent information are complementary to each other in the sense that the offline collection is batched and might be delayed but provides a broader coverage than the online collection. Compared with the online query log database 616 used for online intent detection, the offline query log database 612 may include a much larger number of query logs for a more comprehensive data mining analysis due to the less strict latency requirement for offline intent detection.

The query intent fetching unit 606 is responsible for fetching the most relevant intent based on the received search query. In this example, if more than one intent is determined for a particular query, the offline and online query intent collecting units 602, 604 may further rank the intents based on data mining results and user click feedback. Thus, the query intent fetching unit 606 may provide only the most relevant intent on top of the ranking to the presentation style module 104. For example, a query “rose” may have multiple intents, such as “plant,” “flower,” “name,” or “romance.” If the search is performed on Valentine's Day, the online query intent collecting unit 604 may rank the intent “romance” on top of the potential intents list with a very high weight score based on its real-time updated online query log database 616. Thus, the intent “romance” may be fetched by the query intent fetching unit as the detected intent for the search query “rose” and provided to the presentation style module 104.

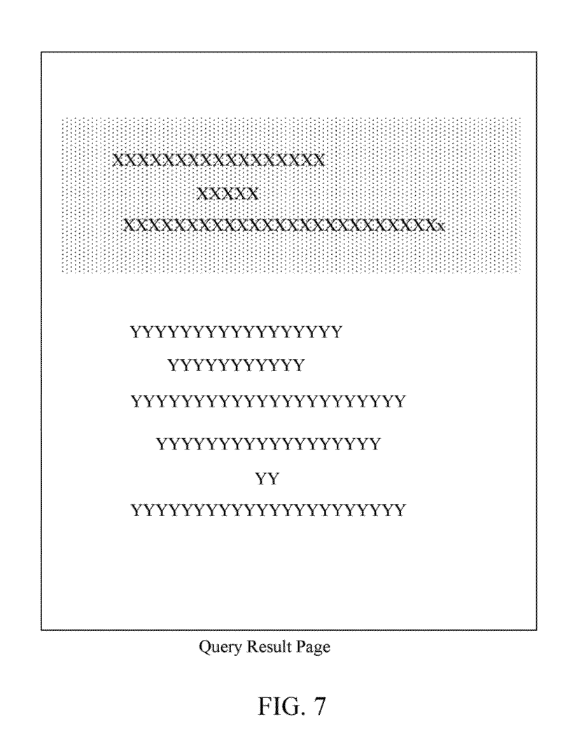

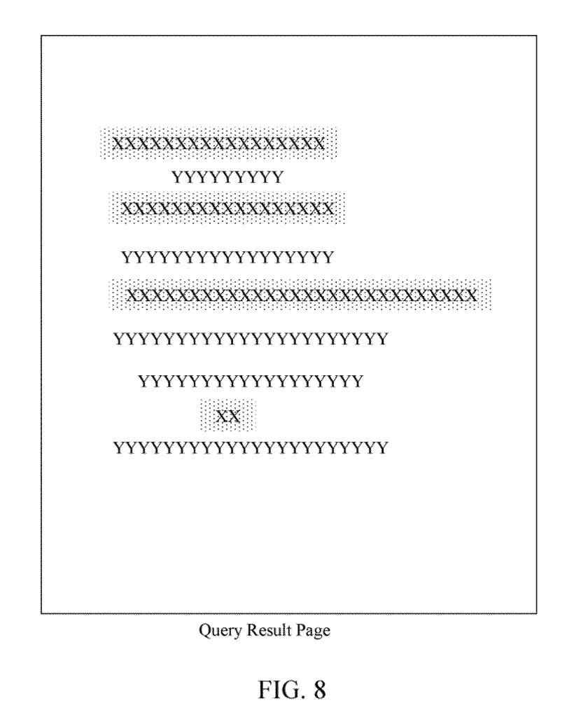

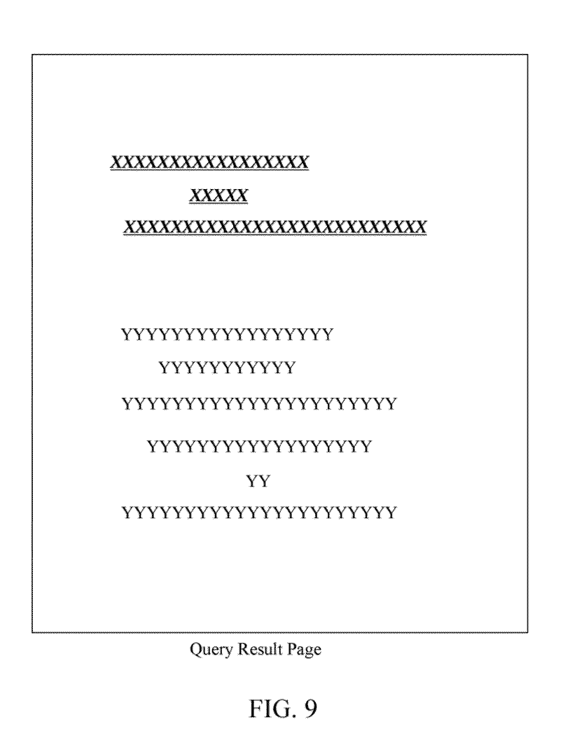

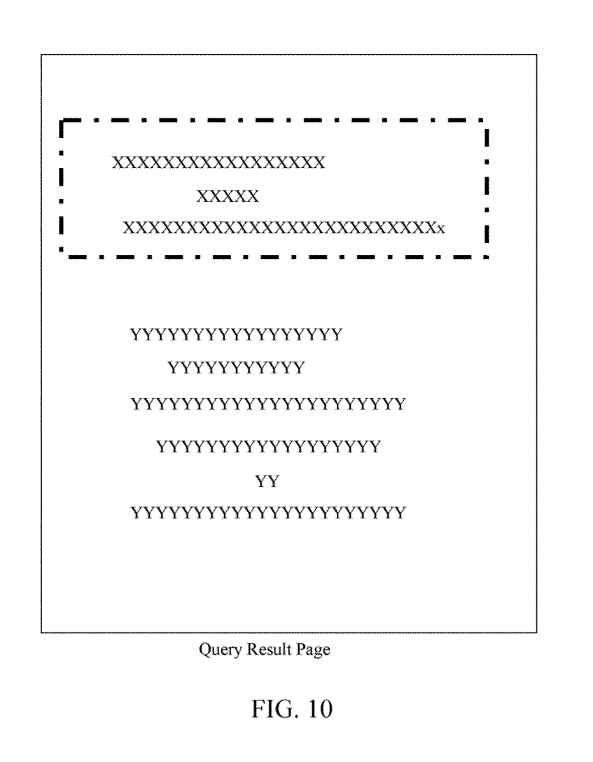

FIGS. 7-10 depict different exemplary query result pages, according to different embodiments of the present teaching. In FIGS. 7-10, “XXXXX” represents the first set of query results, e.g., sponsored query results, and “YYYYYYY” represents the second set of query results, e.g., regular query results. The second set of the query results in FIGS. 7-10 are presented in a default presentation style that does not change based on the search query or the query intent. As to the first set of query results, in FIG. 7, they are presented in a style having a background determined by the detected query intent of the search query. As the intent of the search query changes, the background of the corresponding first set of query results changes. In FIG. 7, the first and second sets of query results are organized in separate sections on the query result page. In FIG. 8, the two sets of query results are mixed together in one section. The second set of query results are presented in the default style, while the first set of query results are presented on a background determined based on the corresponding query intent. In FIG. 9, the first set of query results are presented in a style having a dynamically determined font. In FIG. 10, the first set of query results are presented in a style having a dynamically determined frame. As described above, the background, font, position, frame, image, video, audio, screenshot, any other presenting style, or any combination thereof, may be dynamically determined based on the query intent and applied to the first set of query results, e.g., sponsored query results.

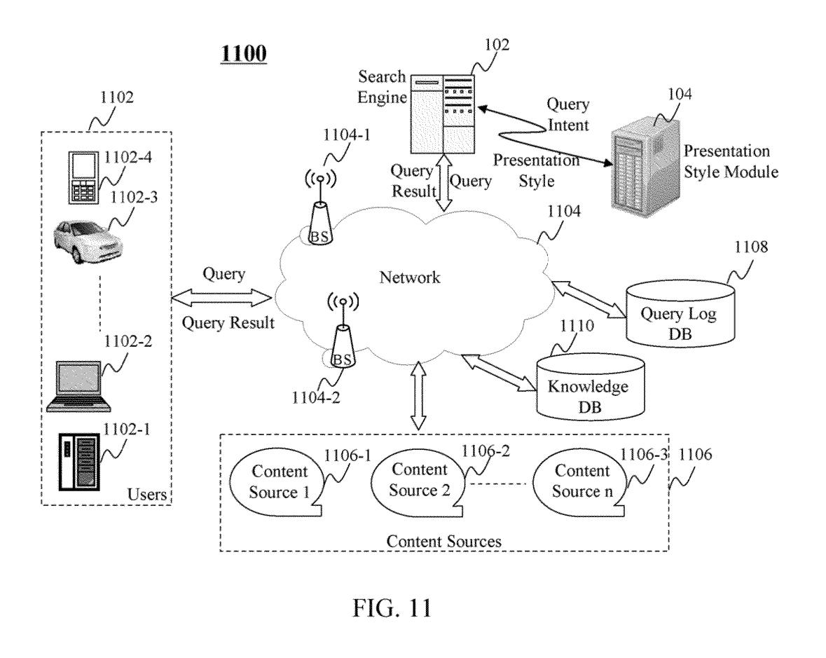

FIG. 11 depicts an exemplary embodiment of a networked environment in which query results presentation is applied, according to an embodiment of the present teaching. In FIG. 11, the exemplary networked environment 1100 includes the search engine 102, the presentation style module 104, one or more users 1102, a network 1104, content sources 1106, a query log database 1108, and a knowledge database 1110. The network 1104 may be a single network or a combination of different networks. For example, the network 1104 may be a local area network (LAN), a wide area network (WAN), a public network, a private network, a proprietary network, a Public Telephone Switched Network (PSTN), the Internet, a wireless network, a virtual network, or any combination thereof. The network 1104 may also include various network access points, e.g., wired or wireless access points such as base stations or Internet exchange points 1104-1, . . . , 1104-2, through which a data source may connect to the network in order to transmit information via the network.

Users 1102 may be of different types such as users connected to the network 1104 via desktop computers 1102-1, laptop computers 1102-2, a built-in device in a motor vehicle 1102-3, or a mobile device 1102-4. A user 1102 may send a query to the search engine 102 via the network 1104 and receive query results from the search engine 102. The results are presented in the styles determined by the presentation style module 104 based on the intent of the query. The query intent may be determined by the query intent module 106 as described above, which may be part of the search engine 102 in this example. In addition, search engine 102 may access information, via the network 1104, stored in the query log database 1108 and knowledge database 1110 for collecting offline and online intent information. The information in the query log database 1108 and knowledge database 1110 may be generated by one or more different applications (not shown), which may be running on the search engine 102, at the backend of the search engine 102, or as a completely standalone system capable of connecting to the network 1104, accessing information from different sources, analyzing the information, generating structured information, and storing such generated information in the query log database 1108 and knowledge database 1110.

The content sources 1106 include multiple content sources 1106-1, 1106-2, . . . , 1106-3, such as vertical content sources. A content source may correspond to a website hosted by an entity, whether an individual, a business, or an organization such as USPTO.gov, a content provider such as cnn.com and Yahoo.com, a social network website such as Facebook.com, or a content feed source such as tweeter or blogs. The search engine 102 may access information from any of the content sources 1106-1, 1106-2, . . . , 1106-3. For example, the search engine 102 may fetch content, e.g., websites, through its web crawler to build a search index.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

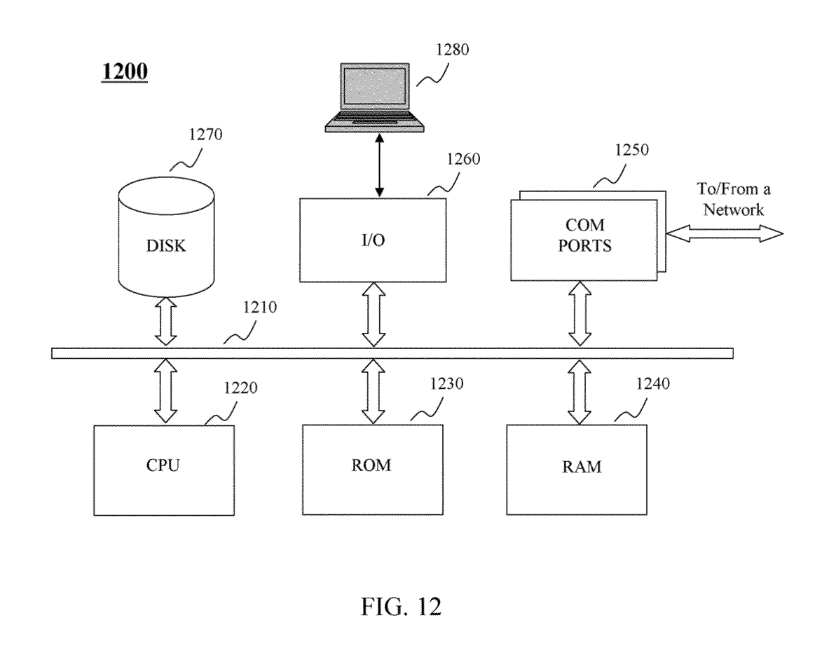

FIG. 12 depicts a general computer architecture on which the present teaching can be implemented and has a functional block diagram illustration of a computer hardware platform that includes user interface elements. The computer may be a general-purpose computer or a special purpose computer. This computer 1200 can be used to implement any components of the query results presentation architecture as described herein. Different components of the system, e.g., as depicted in FIG. 1, can all be implemented on one or more computers such as computer 1200, via its hardware, software program, firmware, or a combination thereof. Although only one such computer is shown, for convenience, the computer functions relating to query results presentation may be implemented in a distributed fashion on a number of similar platforms, to distribute the processing load.

The computer 1200, for example, includes COM ports 1202 connected to and from a network connected thereto to facilitate data communications. The computer 1200 also includes a central processing unit (CPU) 1204, in the form of one or more processors, for executing program instructions. The exemplary computer platform includes an internal communication bus 1206, program storage and data storage of different forms, e.g., disk 1208, read only memory (ROM) 1210, or random access memory (RAM) 1212, for various data files to be processed and/or communicated by the computer, as well as possibly program instructions to be executed by the CPU. The computer 1200 also includes an I/O component 1214, supporting input/output flows between the computer and other components therein such as user interface elements 1216. The computer 1200 may also receive programming and data via network communications.

Hence, aspects of the method of query results presentation, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the modules and units of the system as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method, implemented on at least one machine each of which has at least one processor, storage, and a communication platform connected to a network for presenting query results, the method comprising the steps of:
receiving an input from a user related to a search query;
obtaining a first set of query results and a second set of query results based on the search query;
detecting a query intent based on the search query;
determining a first presentation style associated with the detected query intent for the first set of query results; and
providing the first and second sets of query results to the user, the first set of query results being presented in the first presentation style.

2. The method of claim 1, wherein the first set of query results include sponsored query results and the second set of query results include regular query results.

3. The method of claim 2, further comprising the steps of:
determining a rate of accessing at least one of the first set of query results presented in the first presentation style; and
modifying the first presentation style associated with the detected query intent based on the determined rate.

4. The method of claim 1, further comprising the step of associating a plurality of presentation styles with a plurality of query intents.

5. The method of claim 1, wherein the second set of query results are presented in a second presentation style that is different from the first presentation style.

6. The method of claim 1, wherein the first presentation style includes at least one of background, font, position, frame, image, video, audio, and screenshot.

7. A system for presenting query results, comprising:
a search engine configured to:
receive an input from a user related to a search query; and
obtain a first set of query results and a second set of query results based on the search query;
a query intent module configured to detect a query intent based on the search query; and
a presentation style module configured to determine a first presentation style associated with the detected query intent for the first set of query results, wherein
the search engine is further configured to provide the first and second sets of query results to the user, the first set of query results being presented in the first presentation style.

8. The system of claim 7, wherein the first set of query results include sponsored query results and the second set of query results include regular query results.

9. The system of claim 8, wherein the presentation style module is further configured to:
determine a rate of accessing at least one of the first set of query results presented in the first presentation style; and
modify the first presentation style associated with the detected query intent based on the determined rate.

10. The system of claim 7, wherein the presentation style module is further configured to associate a plurality of presentation styles with a plurality of query intents.

11. The system of claim 7, wherein the second set of query results are presented in a second presentation style that is different from the first presentation style.

12. The system of claim 7, wherein the first presentation style includes at least one of background, font, position, frame, image, video, audio, and screenshot.

13. A machine-readable tangible and non-transitory medium having information for presenting query results recorded thereon, wherein the information, when read by the machine, causes the machine to perform the following:
receiving an input from a user related to a search query;
obtaining a first set of query results and a second set of query results based on the search query;
detecting a query intent based on the search query;
determining a first presentation style associated with the detected query intent for the first set of query results; and
providing the first and second sets of query results to the user, the first set of query results being presented in the first presentation style.

14. The medium of claim 13, wherein the first set of query results include sponsored query results and the second set of query results include regular query results.

15. The medium of claim 14, further comprising the steps of:
determining a rate of accessing at least one of the first set of query results presented in the first presentation style; and
modifying the first presentation style associated with the detected query intent based on the determined rate.

16. The medium of claim 13, further comprising the step of associating a plurality of presentation styles with a plurality of query intents.

17. The medium of claim 13, wherein the second set of query results are presented in a second presentation style that is different from the first presentation style.

18. The medium of claim 13, wherein the first presentation style includes at least one of background, font, position, frame, image, video, audio, and screenshot.

19. A method, implemented on at least one machine each of which has at least one processor, storage, and a communication platform connected to a network for presenting query results, the method comprising the steps of:
associating a plurality of presentation styles with a plurality of query intents;
determining one of the plurality of presentation styles based on one of the plurality of query intents, wherein the one of the plurality of query intents is detected based on a search query;
applying the determined presentation style to one or more query results obtained based on the search query;
determining a rate of accessing at least one of the one or more query results presented in the determined presentation style; and
modifying the determined presentation style based on the determined rate.

20. A system for presenting query results, comprising:
a mapping unit configured to associate a plurality of presentation styles with a plurality of query intents;
an assigning unit configured to:
determine one of the plurality of presentation styles based on one of the plurality of query intents, wherein the one of the plurality of query intents is detected based on a search query; and
apply the determined presentation style to one or more query results obtained based on the search query; and
a refining unit configured to:
determine a rate of accessing at least one of the one or more query results presented in the determined presentation style; and
modify the determined presentation style based on the determined rate.

21. A machine-readable tangible and non-transitory medium having information for presenting query results recorded thereon, wherein the information, when read by the machine, causes the machine to perform the following:
associating a plurality of presentation styles with a plurality of query intents;
determining one of the plurality of presentation styles based on one of the plurality of query intents, wherein the one of the plurality of query intents is detected based on a search query;
applying the determined presentation style to one or more query results obtained based on the search query;
determining a rate of accessing at least one of the one or more query results presented in the determined presentation style; and
modifying the determined presentation style based on the determined rate.
